(19) United States
(12) Patent Application Publication
(10) Pub. No.: US 2026/0219019 A1
(43) Pub. Date: Jul. 30, 2026

(54) MEASURING ROD WITH DETACHABLE COMPONENTS

(71) Applicant: Petros GIANKOULAS, MIDLAND (CA)

(72) Inventor: Petros GIANKOULAS, MIDLAND (CA)

(21) Appl. No.: 19/038,840

(22) Filed: Jan. 28, 2025

(51) Int. Cl. G01B 3/04; G01C 9/34; G01C 15/00

(52) U.S. Cl. CPC G01B 3/04; G01C 9/34; G01C 15/004

(57) ABSTRACT

The invention is a measuring rod designed to locate predetermined points on upright structures or fence posts during construction. It includes an elongated bar positioned beside a post, with multiple slidable, removable, and attachable markers that align against the post to indicate marking points for installing stringers or similar components. Additionally, the rod incorporates slidable, removable spacers to ensure accurate spacing between boards. It also features removable, attachable lasers for precise measurements in various fencing styles.

### FIELD OF THE INVENTION

The present invention relates to a measuring rod with detachable components designed for constructing fences and other structures that require horizontal and vertical measurements for strength, durability and stability.

### BACKGROUND OF THE INVENTION

In the construction industry, particularly in fencing but not limited to such, achieving accurate alignment of posts and stringers (also know as braces for the posts) that stretch from post to post to secure the fence posts from twisting as well as holding the fence boards and evenly spacing the boards is crucial for both aesthetics and structural integrity. Traditional methods often rely on manual measurements and visual estimates, which can lead to inaccuracies, especially when working on uneven terrain. Additionally, the use of standard measuring tools can be cumbersome and may not provide the desired level of precision required for standard or high-quality fence installations but not limited to such.

Current marking devices on the market typically lack features that accommodate varying ground conditions or provide the user with a clear visual reference for alignment. Furthermore, many existing solutions do not allow for easy adjustment or customization to suit specific project requirements from one installation to the next or provide an all in one tool for the construction of a fence and other structures. This often results in time-consuming adjustments and potential errors during installation.

The invention described herein addresses these challenges by providing a versatile, user-friendly measuring rod that combines the benefits of adjustable components on a main body, including locking mechanisms, board spacers and a laser projection system all in one. This innovative approach allows users to achieve greater accuracy and efficiency in their fencing projects but not limited to such, thereby improving overall construction strength, durability, stability, quality and drastically reducing the time spent on manual measurements.

### SUMMARY OF THE INVENTION

The present invention relates to a measuring rod with detachable components designed for constructing fences and other structures. The measuring rod with detachable components comprises an elongated bar shaped as a rectangular elongated bar, a plurality of spacers, designed to provide predetermined measurement points, spirit levels, a plurality of markers with levels designed to level materials and other objects, a plurality of modular straps to hold the invention to the structure, a laser projection system for accuracy and an extension leg that is connected to the main body. The markers include a 360-degree rotating spirit level, a locking mechanism, and a plurality of vertical and horizontal marking lines that are projected with lasers. The locking mechanism allows the marker to be secured to or released from the main body, depending on whether it is in the active or inactive state, respectively, and the plurality of vertical and horizontal marking lines provides specific measurement points.

The elongated bar comprises of a single elongated bar or a plurality of segmented elements arranged lengthwise to create a continuous elongated bar. The surface of the elongated bar is marked with measurement points to facilitate accurate measurement. Along the length of the elongated bar are two tapered grooves: a first groove located on one side and a second groove positioned on the opposite side. A steel sheet is embedded in the base surface of the first groove, while a series of magnets are embedded within the second groove. Each marker and spacer includes a male wedge extending along their length. The wedges are designed to fit into the grooves on the main body, allowing the markers and spacers to slide along the body for easy adjustment.

The markers are designed to indicate specific measurement points directly on the post. By aligning the markers with the spacers, users can quickly mark the locations for cutting grooves or attaching stringers. This ensures precision in the installation process and reduces the potential for measurement errors that can arise from traditional measuring methods.

The spacers are secured to the elongated bar through magnetic attraction, by the steel sheets embedded in the male wedges of the spacers that interact with the magnets in the first groove. The locking mechanism of the markers is equipped with a lever, a magnet housed in a recess on the male wedge, and a linkage bar that connects the lever to the magnet. When the lever is pulled or pressed, it moves the magnet out of or into the recess. In the active state, the magnet aligns with the male wedge, creating a strong magnetic attraction with the steel sheet in the second groove, securing the marker to the main body. In the inactive state, the magnet retracts into the recess, reducing the magnetic attraction and allowing the marker to be released.

The spacers are used to establish predetermined points along the measuring rod. By positioning the spacers against the post, users can quickly identify where horizontal stringers should be affixed. This eliminates the need for repeated measurements with a tape measure, significantly speeding up the installation process. The connection between the spacer and the elongated bar allows for secure attachment and easy adjustments.

The measuring rod further features a laser integrated system on the marker body that shines parallel to the vertical and horizontal marking lines on the invention, helping to align posts and main stringers but not limited to such accurately during fence installations but not limited to such. The laser system has adjustable brightness settings to accommodate various ambient light conditions.

The modular strap, comprises a strap housed within a strap body, a hook connected to the free end of the strap. The strap can be extended from the body, wrapped around a post, or other structures, and locked into a male connector on the strap body. A rotary knob is used to retract the strap into the housing, tightening it securely around the structure and pulling any excess strap back into the body.

The extension leg provides additional stability to the device by preventing it from touching the ground. This is particularly beneficial on uneven terrain, as it allows the measuring rod to maintain an accurate position relative to the post. The leg can be adjusted in height to accommodate varying ground levels, ensuring that the bottom of the device remains elevated for consistent measurements. In one embodiment, the extension leg is designed with two parts connected via a threaded mechanism for height adjustment and comprises a locking mechanism to secure the leg once it is in the desired position. The modular strap is configured to wrap around a post or other structures, providing stability during measurements.

The entire device is made from a lightweight yet durable material, ensuring ease of transport while maintaining strength and functionality.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1A shows an isometric view of one embodiment of the invention;

FIG. 1B shows another isometric view of the embodiment of the invention;

FIG. 2A shows a close-up view of a elongated bar of the invention;

FIG. 2B shows another close-up view of the elongated bar of the invention;

FIG. 2C shows another close-up view of the elongated bar of the invention;

FIG. 3 shows a top view of the embodiment of the invention;

FIG. 4 shows an exploded top view of the embodiment of the invention;

FIG. 5A shows a close-up view of a first groove of the elongated bar of the embodiment of the invention;

FIG. 5B shows a close-up view of a second groove of the elongated bar of the embodiment of the invention;

FIG. 6A shows a close-up view of a spacer being inserted into the main body;

FIG. 6B shows a close-up view of the spacer being attached to the main body;

FIG. 7 shows one embodiment of a marker used in the device;

FIG. 8A shows a close-up view of the marker with a locking mechanism in an inactive state;

FIG. 8B shows a close-up view of the marker with the locking mechanism in an active state;

FIG. 9A shows a cross-sectional view of the marker and the locking mechanism in the inactive state;

FIG. 9B shows a cross-sectional view of the marker and the locking mechanism in the active state;

FIG. 10 shows another embodiment of a marker used in the device;

FIG. 11 shows another view of the embodiment of the marker with a laser;

FIG. 12 shows a close-up view of an extension leg of the embodiment of the invention;

FIG. 13 shows a close-up view of the extension leg detached from the main body; FIG. 14A shows one embodiment of a modular strap used in the device;

FIG. 14B shows another view of the embodiment of the modular strap used in the device;

FIG. 15 shows a close-up view of the embodiment of the modular strap used in the device;

FIG. 16A shows the device positioned on a wooden post;

FIG. 16B shows another view of the device positioned on a wooden post;

FIG. 17A shows the device positioned between two vertical wooden boards on a fence, and

FIG. 17B shows a close-up view of the device positioned between two vertical wooden boards on a fence.

### DETAILED DESCRIPTION

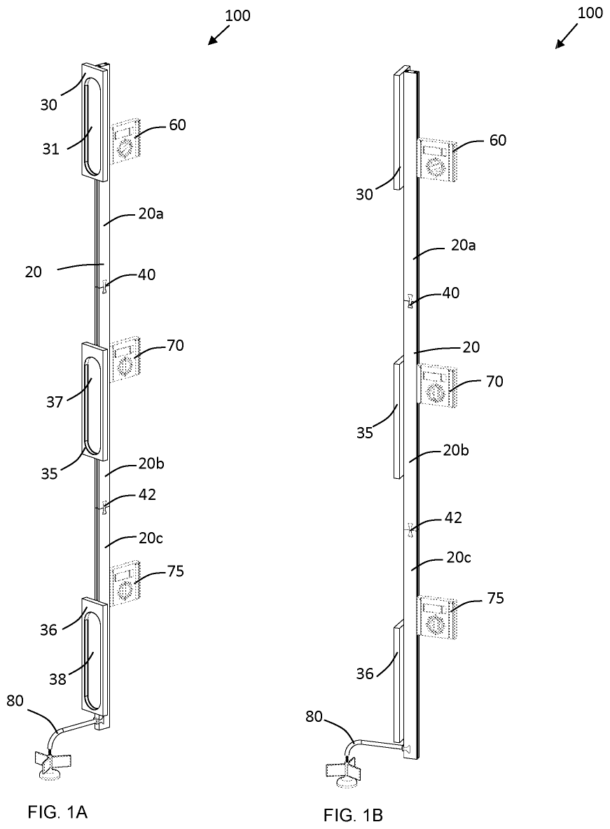

FIGS. 1A and 1B show isometric views of one side and another side of one embodiment of the measuring rod device 100. The measuring rod device 100 is a measuring rod with detachable components for use in the construction of a fence and other structures, comprising an elongated bar 20 that is an elongated bar, a plurality of spacers 30, 35, and 36, a plurality of marker bodies 60, 70, and 75, and an extending leg 80. The plurality of spacers 30, 35, and 36, the plurality of marker bodies 60, 70, and 75, and the extending leg 80 are connected to the elongated bar 20. The elongated bar 20 can be a single bar (not shown) or made from a plurality of segmented bars 20a, 20b, and 20c arranged lengthwise to form a continuous configuration of the elongated bar. The segmented bars 20a, 20b, and 20c are connected by a plurality of connectors 40 and 42. The device 20 uses magnetic attraction to secure its connection between the plurality of spacers 30, 35, and 36, the plurality of marker bodies 60, 70, and 75, and the extending leg 80, facilitating detachment and reattachment while maintaining a reliable and robust connection.

The device can be used in the construction of structures consisting of components that must be aligned including but not limited to the construction of a fence, and prefabricated buildings and frameworks for storage of boats and cars.

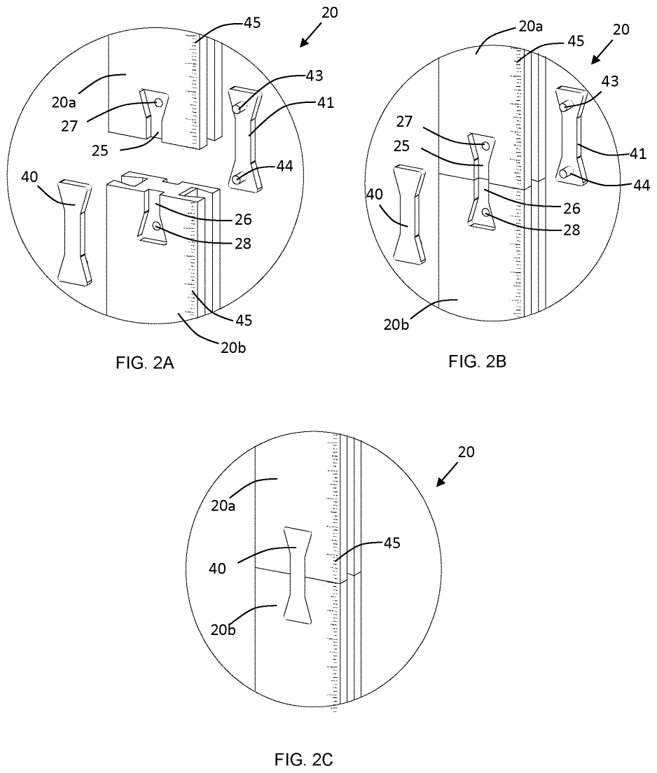

FIGS. 2A, 2B, and 2C illustrate close-up views of the elongated bar 20, showing the connection between the two segment bars 20a and 20b in one embodiment of the invention. Two segment bars 20a and 20b are connected via two connectors 40 and 41, each for connecting one side of the segment bars 20a and 20b. Each of the connectors 40 and 41, have two male rods positioned at opposite ends of the hourglass profiles on the same surface, one rod on each end of the hourglass. FIG. 2A and FIG. 2B show the male rods 43 and 44 of one of the connectors 41. The segmented bars 20a and 20b each contain recesses 25 and 26 near their connection point, on both surfaces. FIG. 2A shows the recesses 25 and 26 on one side of the segment bars 20a and 20b. When two segmented bars 20a and 20b align, their recesses 25 and 26 form an hourglass-shaped cavity corresponding to the profile of their corresponding connectors 40 and 41. The recesses 25 and 26 have female slots 27 and 28 designed to engage the male rods of their corresponding connector 40. Upon pressing the connector 40 into the recesses 25 and 26 of the aligned segmented bars 20a and 20b the male rods are securely engaged within their corresponding female slots, resulting in a flush connection where the connectors'surfaces 40 and 41 align with the surfaces of the segmented bars 20a and 20b (FIG. 2C). The connection between the other segment bars 20b and 20c is similar to what that described herein. This configuration ensures a secure connection between the segmented bars 20a, 20b, and 20c, allowing them to be interconnected to form the elongated bar of the elongated bar 20. The bars can be disconnected by removing their connectors, facilitating portability and reconfiguration as needed.

As shown in FIGS. 2A, 2B, and 2C, the marker further has marking points 45 on its surface. These marking points serve as precise reference indicators for measurements and facilitate the installation of components on the elongated bar of the device. In one embodiment of the device the marking points can stretch from zero inches to seventy-two inches. Other markings points can be used as needed.

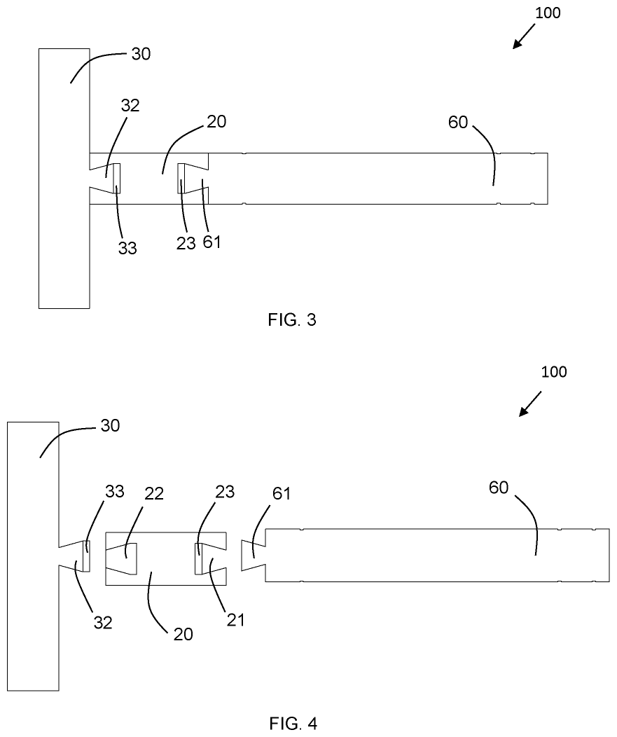

FIGS. 3 and 4 show a top view and an exploded top view of the embodiment of the invention, respectively. The elongated bar 20 comprises two tapered grooves: a first groove 21 and a second groove 22 extending along its length, positioned on the opposite sides of the elongated bar 20. A steel sheet 23 is embedded in the base surface of the first groove 21, covering the entire surface. The marker 60 from the plurality of the markers 60, 70, and 75 comprises a male wedge 61, extending along its length on one side. The shape of the male wedge 61 matches the dimensions of the first groove 21 of the elongated bar 20 and is configured to fit within the first groove 21 and slide along the length of the elongated bar 20. The spacer 30 from the plurality of the spacers 30, 35, or 36 features a male wedge 32 extending along its length on one surface positioned vertically in the middle of the spacer's surface 30. The male wedge 32 of the spacer 30 has a steel sheet 33 embedded at its base surface, covering the entire surface, and is designed to match the dimensions of the second groove 22 of the elongated bar 20 and is configured to be inserted into or removed from the said groove 22 and slide along the length of the elongated bar 20. The rest of the plurality of the spacers 35 and 36 and the plurality of the markers 70 and 75 have a similar configuration to the spacer 30 and the marker 60 described herein, respectively. This configuration ensures that the components remain precisely aligned with the elongated bar 20 during use, allowing for easy and controlled adjustment of the components'placement by the user.

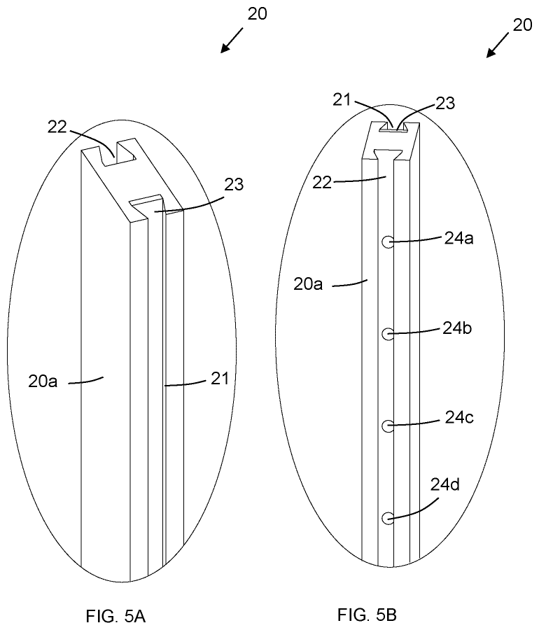

FIGS. 5A and 5B illustrate close-up views of two sides of the elongated bar 20, showing the first and second grooves 21 and 22, respectively. The base of the first groove 21 is covered by a steel sheet 23. The steel sheet 23 provides magnetic attraction when it is in contact with a magnet. As shown in FIG. 5B, a plurality of disk-shaped magnets 24a, 24b, 24c, and 24d are embedded within the base of the second groove 22, with the surface of each magnet 24a, 24b, 24c, and 24d aligned flush with the surface of the base of the second groove 22. The magnets 24a, 24b, 24c, and 24d are aligned linearly along the length of the second groove 22, with spacing configured to optimize magnetic force distribution. The magnets 24a, 24b, 24c, and 24d attract the steel sheets embedded in the corresponding male wedge of the spacers 30, 35, and 36. This magnetic attraction locks the male wedge 33 securely within the second groove 22. The strength and positioning of the magnets 24a, 24b, 24c, and 24d are calibrated to provide sufficient holding force, preventing accidental disconnection during use while allowing intentional detachment with the application of adequate force.

In other embodiments of the device, the magnets may have various shapes, including but not limited to oval, cylindrical, ring, arc, and block shapes. Additionally, in some embodiments, the magnets may fully cover the base of the second groove for enhanced magnetic retention.

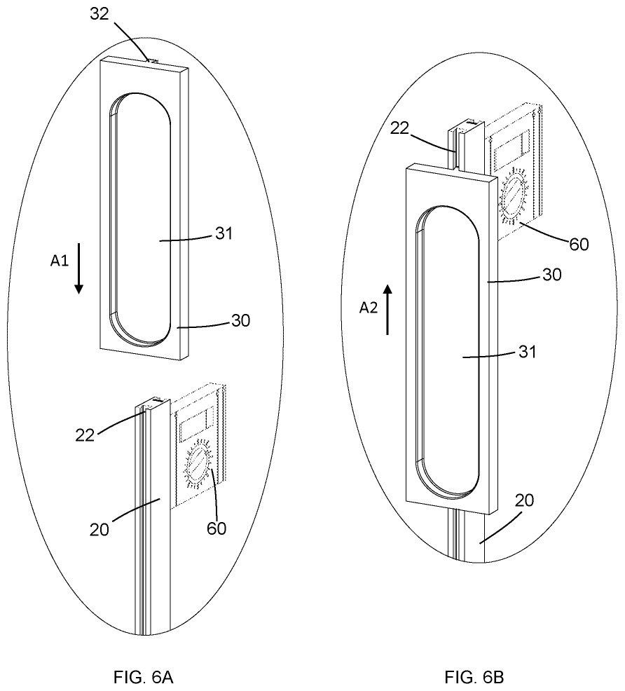

FIGS. 6A and 6B illustrate close-up views of a spacer 30 from the plurality of spacers 30, 35, and 36 being inserted into and attached to the elongated bar 20, respectively. To attach the spacer 30 to the elongated bar 20, the spacer 30 is positioned above the elongated bar 20, with the male wedge 32 of the spacer 30 aligned with the second groove 22. The male wedge 32 is then inserted into the second groove 22. A1 indicates the direction in which the spacer 30 is inserted. Once the spacer 30 is fully inserted (FIG. 6B), the steel sheet 33 on the base of the male wedge 32 is attracted to the magnets embedded in the second groove's base 22, forming a secure attachment through magnetic attraction. To detach, the spacer 30 can be pulled out of the elongated bar 20 by applying sufficient force to overcome the magnetic attraction. A2 indicates the direction of removal. This configuration offers both a secure and detachable connection due to the combination of the tapered design of the second groove 22 and magnetic force. The tapered design is to prevent lateral movement when the male wedge 32 is inserted into the groove 22. The magnets embedded in the base of the second groove 22 generate a strong magnetic attraction to the steel sheet 33 on the male wedge base 32, holding the spacer 30 firmly in place and preventing it from slipping out. The connection remains detachable because the magnetic attraction, while strong enough to secure the spacer 30 during use, can be overcome by applying sufficient pulling force. This allows the spacer 30 to be easily removed.

As shown in FIGS. 1A, 1B, 6A, 6B, the spacers have round edge rectangle grooves 31, 37, and 38. The grooves 31, 37, and 38 are carved within the surface of the spacers to reduce their weight and overall weight of the measuring rod for ease of use. The spacers 30, 35, and 36 can have various sizes including but not limited to one inch, one and a half inches, two inches, two and a half inches, three inches, and three and a half inches, etc. Spacers 30, 35, and 36 can be made in various size increments including but not limited to sixteenth-inch increments, one-eighth-inch increments, one-quarter-inch increments, one-inch increments, and two-inch increments.

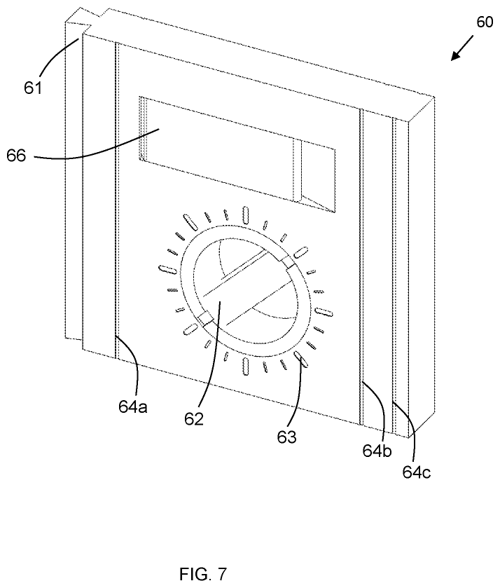

FIG. 7 shows one embodiment of a marker 60 from the plurality of markers 60, 70, and 75 used in the device. The marker 60 comprises a rotating spirit level 62, a locking mechanism, and a plurality of vertical marking lines (cuts) 64a, 64b, and 64c (. The integrated rotating spirit level 62 allows for precise leveling in multiple orientations. Surrounding the spirit level 62 are 360-degree markers 63 that provide visual indicators at regular intervals, facilitating accurate leveling and alignments in all directions. The plurality of the vertical marking lines (cuts) 64a, 64b, and 64c are used to mark lines on posts and other structures according to different fencing styles. In one embodiment, the three vertical marking lines (cuts) 64a, 64b, and 64c correspond to common fencing styles: one line 64a for a “Good Neighbor” or “Shadow Box” style, positioned on the left side of the marker 60 near the elongated bar 20, a second line 64c for a “Board and Batten” style, positioned on the right side of the marker 60, and a third line 64b for a “Board on Board” or “Board to Board” style, positioned between the other two lines 64a and 64c on the right side of the marker 60. The three marking lines 64a, 64b, and 64c may be distinguished by color coding, allowing for easy identification and differentiation. The locking mechanism is designed to secure the marker 60 to the elongated bar 20, holding it firmly in place and preventing any vertical movement along the elongated bar 20 when in its active state. A lever 66 is configured on the marker 60 to switch the locking mechanism between active and inactive states. In the active state, the marker 60 remains fixed at the desired position. In the inactive state, the marker 60 can move freely through the first groove 21, allowing for removal or adjustment.

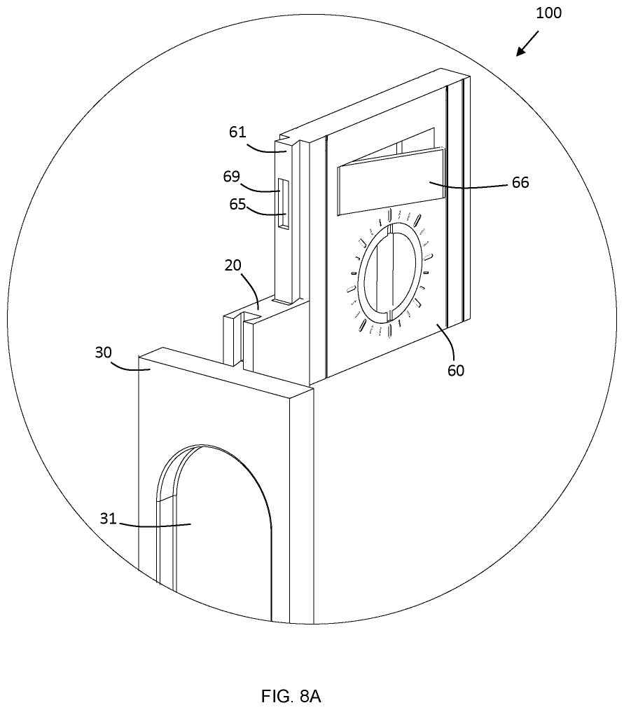

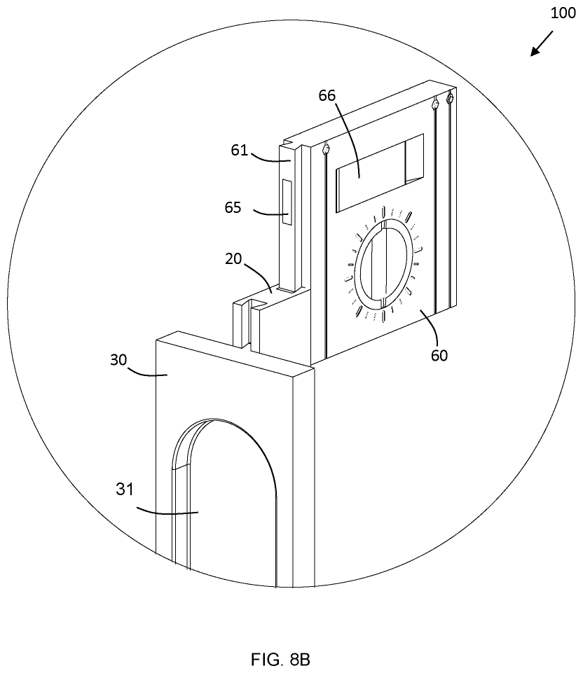

FIGS. 8A and 8B show close-up views of marker 60 from the plurality of the markers 60, 70, and 75 with the locking mechanism in active and inactive states, respectively. The marker 60 includes a rectangular recess 69 on its male wedge 61, with a magnet 65 positioned inside the recess 69. The lever 66 is configured on the marker 60 to switch the locking mechanism between active and inactive states. When the lever 66 is pulled outward from the marker's surface 60, the magnet 65 moves away from the male wedge surface 61 and toward the end of the recess 69, reducing the magnetic attraction with the steel sheet 23 of the first groove 21. In this inactive state, the magnet 65 is positioned at the farthest point from the steel sheet 23, allowing the marker 60 to move freely along the first groove 21 and adjust its position on the elongated bar 20. When the lever 66 is pressed toward the male wedge 61, the magnet 65 moves toward the male wedge 61, aligning with it and increasing the magnetic attraction with the steel sheet 23. In this active state, the magnet 65 is positioned closest to the steel sheet 23, locking the marker 60 to remain fixed at its position.

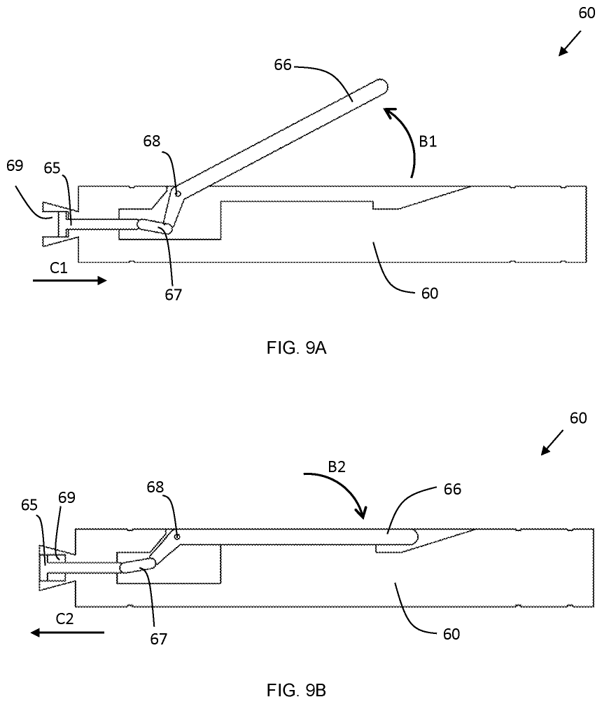

FIGS. 9A and 9B show cross-sectional views of the marker 60 and the locking mechanism. The locking mechanism comprises a lever 66, a T-shaped magnet 65, and a linkage bar 67. The magnet 65 can have a uniform magnetic attraction throughout its structure or have enhanced magnetic attraction on its surface. The lever 66 features a rectangular surface that is slightly folded on one side, creating an angled section. The lever 66 is formed from a continuous piece of material, with the folded section designed to withstand repeated use. The linkage bar 67 is pivotally hinged to the stem end of the T-shaped magnet 65 at the end and the folded side of the lever 66 at the other end. The lever 66 is also pivotally hinged at its angled section, with a hinge 68 fixed to the marker 60, allowing the lever 66 and the folded side to pivot around the hinge's axis 68. In FIG. 9A, when the lever is pulled in the B1 direction, the folded side pivots around the hinge axis 68, pulling the linkage bar 67 away from the elongated bar 20. This action also pulls the magnet 65 away from the steel sheet 23 of the elongated bar 20, disconnecting the marker 60 from the elongated bar 20. C1 indicates the direction of the magnet's movement. In FIG. 9B, when the lever 66 is pushed in the B2 direction, the folded side pivots around the hinge axis 68 and pushes the linkage bar 67 toward the elongated bar 20. This movement pushes the magnet 65 closer to the steel sheet 23 of the elongated bar 20, re-establishing the connection with the marker 60. C2 indicates the direction of the magnet's movement.

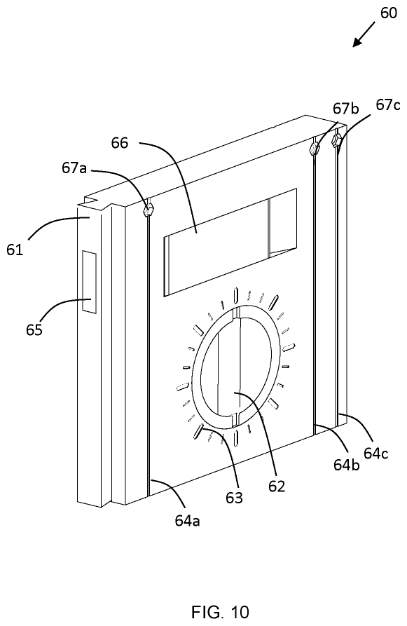

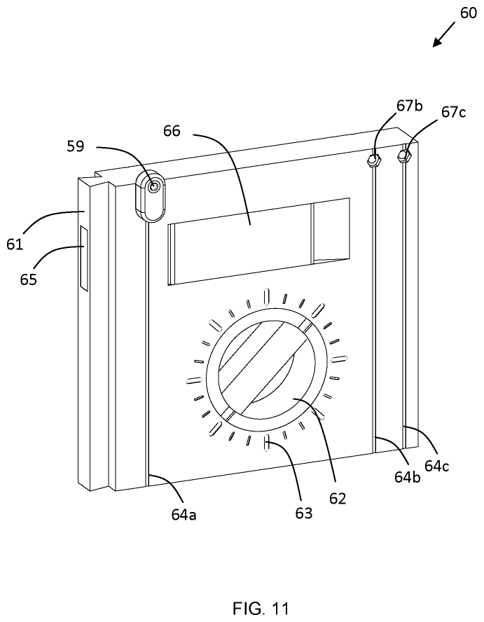

FIGS. 10 and 11 show a marker 60, the marker 60 comprises a male wedge 61 corresponding to the first groove 21, a rotating spirit level 62, 360-degree markers 63 surrounding the spirit level 62, a plurality of vertical marking lines (cuts) 64a, 64b, and 64c, and a locking mechanism including: a lever 66, a linkage bar, a hinged, and a magnet 65. The marker 60 features a plurality of specialized cuts 67a, 67b, and 67c within the marker 60, positioned at the end of the vertical marking lines (cuts) 64a, 64b, and 64c, respectively. Each of the plurality of the cuts 67a, 67b, and 67c are configured to house a laser device. FIG. 11 shows a laser device 59 positioned on one of the vertical marking line 64a. The laser device 59 emits a beam parallel to the vertical marking lines (cuts) 64a, 64b, and 64c and the top of the marker 60. By utilizing the laser device 59, the user can project a laser light onto a next post while the measuring tool remains on a first post, ensuring accurate alignment and measurement throughout the installation process. The laser device 59 attachable on each marker 60 shines vertical and horizontal laser lines, allowing for precise alignment of posts, stringers and boards during installation.

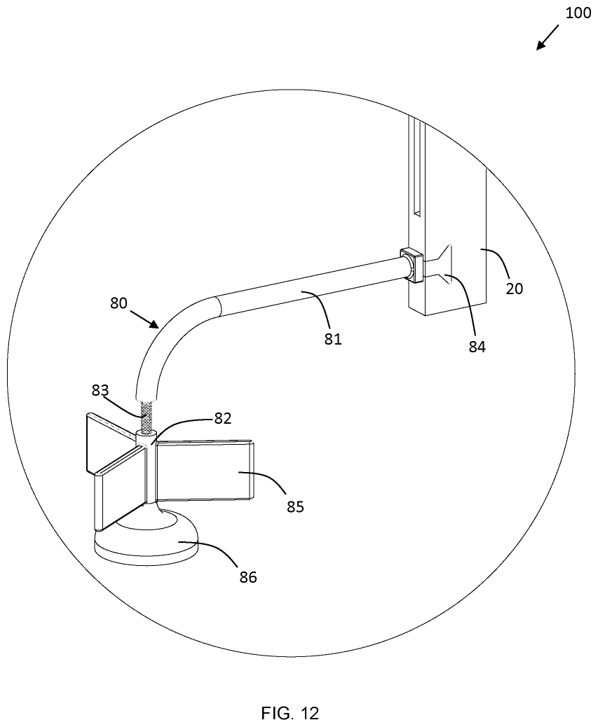

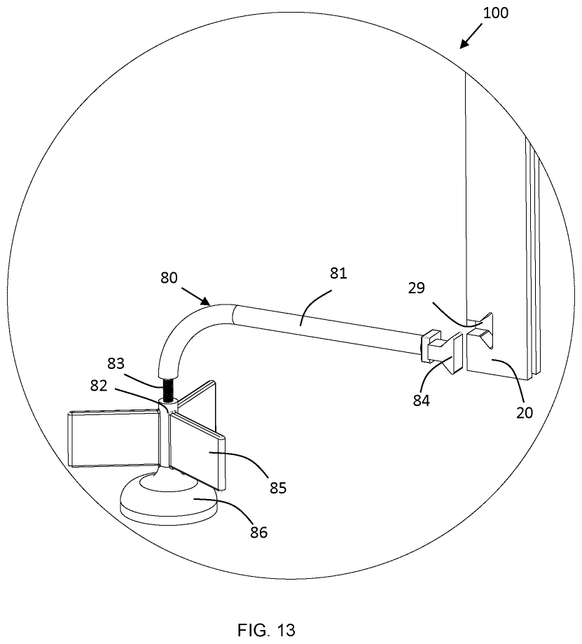

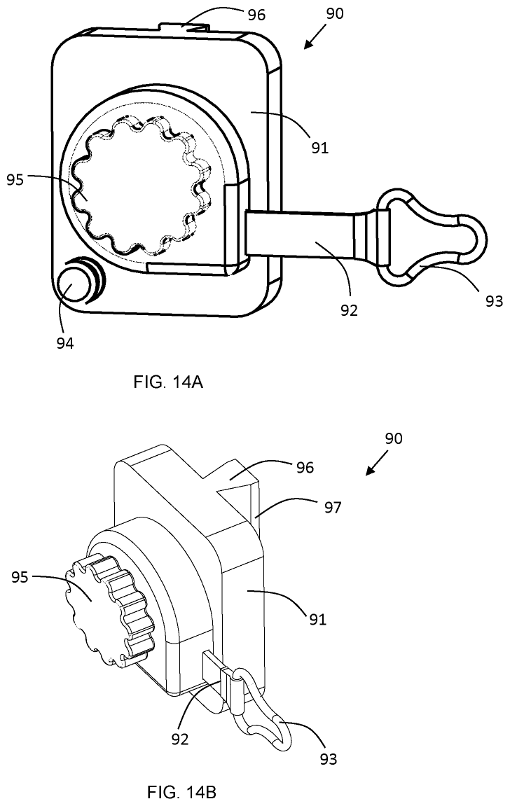

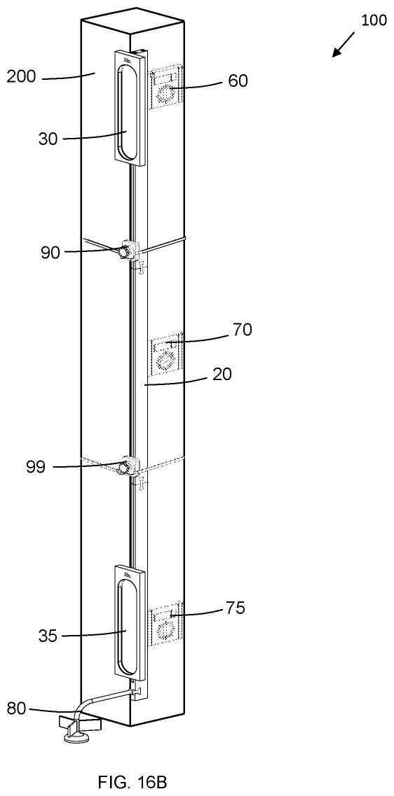

FIGS. 12 and 13 show close-up views of the extension leg 80 of the measuring rod device 100. The extension leg 80 has an arc shape and comprises a first part 81 connected to the elongated bar 20 and a second part 82 connected to the first part 81. The first part 81 features a male screw 83 on one end and a magnetic dovetail 84 connector at the other end. The male screw 83 is configured to connect with a corresponding female thread embedded in the upper side of the second part 82. The elongated bar further has a socket 29 corresponding to the dovetail connector 84 with its base covered with a steel sheet. By inserting the dovetail connector 84 into the socket 29 the magnetic attraction and friction prevent the leg 80 from moving both vertical and lateral. The second part 82 has a three-wing pedal 85 and a wider design at the lower part 86 with a circular base to provide stability on the ground. The pedal 85 is configured to control the connection between the first part 81 and the second part 82 allowing for height adjustment of the measuring rod device 100 relative to the ground. By rotating the pedal 85 the screw 83 moves through the thread and increases and decreases the height of the connection. This adjustment is typically made only once for each project, as the height of all the posts must remain uniform. The extension leg 80 is configured to ensure that the bottom of the measuring rod device 100 does not touch the ground after placing the fence posts 200 (shown in FIG. 16) into the ground, as the soil around each post 200 may become uneven due to the digging process. By utilizing the extension leg 80, the bottom of the measuring rod device 100 can rest on a more even portion of the ground.

FIGS. 14A and 14B show a front view and an isometric view of one embodiment of a modular strap 90. The modular strap 90 comprises a body 91, with a strap 92 housed inside the body 91. The strap 92 has a free end that extends out of one side of the body 91 and a hook 93 attached to the free end. A male connector 94 is positioned on the surface of the body. A rotary knob 95 is positioned on the same surface, and a male wedge 96 extends along the length of the body 91 on the surface opposite the male connector 94 and rotary knob 95, with a steel sheet 97 covering the base of the male wedge 96. By pulling the hook 93, the strap 92 is extended out of the body 91. The strap 92 can be locked to the male connector 94 via the hook 93. The male connector 94 has a head that is wider than its stem to ensure secure engagement. The wider portion of the hook 93 is designed to pass through the male connector 94, while the narrower portion of the hook 93 locks around the male connector 94, ensuring a stable and secure connection between the strap 92 and the body 91. The rotary knob 95 allows the strap 92 to be retracted into the body 91 by rotating the knob 95. This mechanism provides the ability to tighten or retract the strap 92 as needed, ensuring secure fastening or convenient storage of the strap 92 within the body 91.

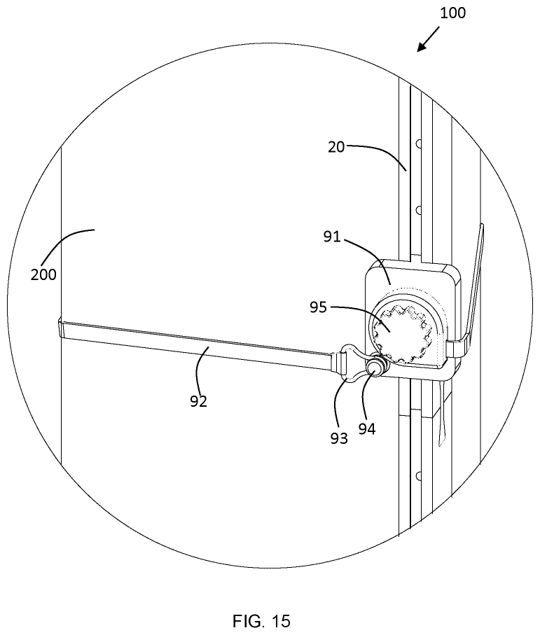

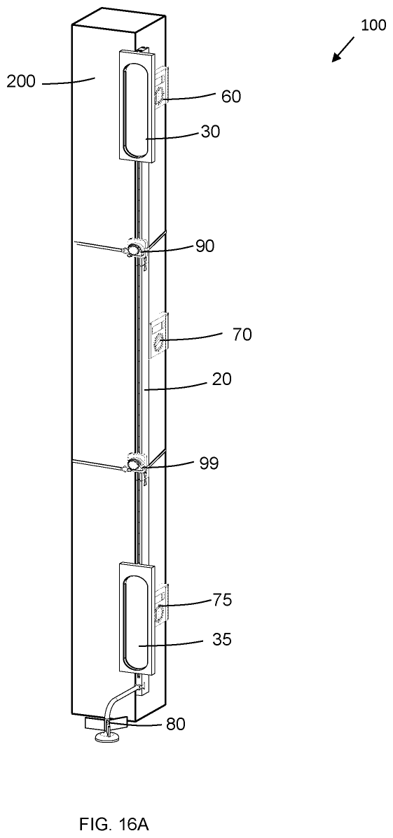

FIGS. 15 and 16A and 16B illustrate a close up view of the modular strap 90 from a plurality of the modular straps 90 and 99 in use, securing the measuring rod device 100 on a post 200. The modular strap 90 is inserted within the second groove 22 of the elongated bar 20. The magnetic attraction between the steel sheet 97 on the male wedge 96 of the modular strap 90 and the magnet embedded in the second groove 22 secure the modular strap 90 in its place. The strap 92 extends from the body 91, wraps securely around the post 200, and is locked in place by engaging the hook 93 with the male connector 94 positioned on the surface of the body 91. The wider part of the hook 93 passes through the male connector 94, and the narrower section locks into place, providing a stable connection. This setup holds the measuring rod device 100 securely against the post, preventing any movement. The rotary knob 95, located on the surface of the body 91, can be used to tighten the strap 92 further or retract it as needed, ensuring that the measuring rod device 100 remains fixed in position for accurate measurement or alignment.

FIGS. 16A and 16B illustrate the measuring rod device 100 positioned on a post 200, showcasing its various components in action to facilitate the installation of wooden fences. The measuring rod device 100 comprises spacers 30 and 35 and markers 60, 70, and 75, to ensure accurate and efficient measurements during the fence installation process. The main body 20 and spacers feature a 90-degree edge, allowing it to securely connect to the edge of the post 200. This design provides a stable mounting point for the measuring rod device 100, ensuring that it aligns perfectly with the post 200 and allowing for easy adjustments. The markers 60, 70, and 75 are designed to indicate specific measurement points directly on the post 200. By positioning the markers 60, 70, and 75 against the post 200, users can identify where horizontal stringers should be affixed and they can mark the locations for cutting grooves or attaching stringers. This eliminates the need for repeated measurements with a tape measure, significantly speeding up the installation process. The extension leg 80 provides additional stability to the device 10 by preventing it from touching the ground. This is particularly beneficial on uneven terrain, as it allows the measuring rod device 100 to maintain an accurate position relative to the post 200. The leg 80 can be adjusted in height to accommodate varying ground levels, ensuring that the bottom of the measuring rod device 100 remains elevated for consistent measurements. The plurality of the modular straps 90 and 99 secure the measuring rod device 100 on a post 200.

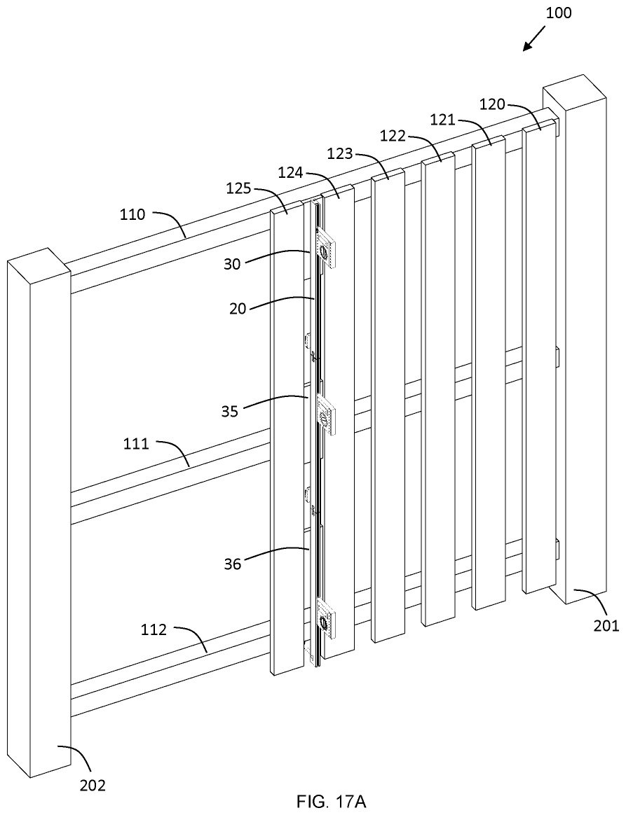

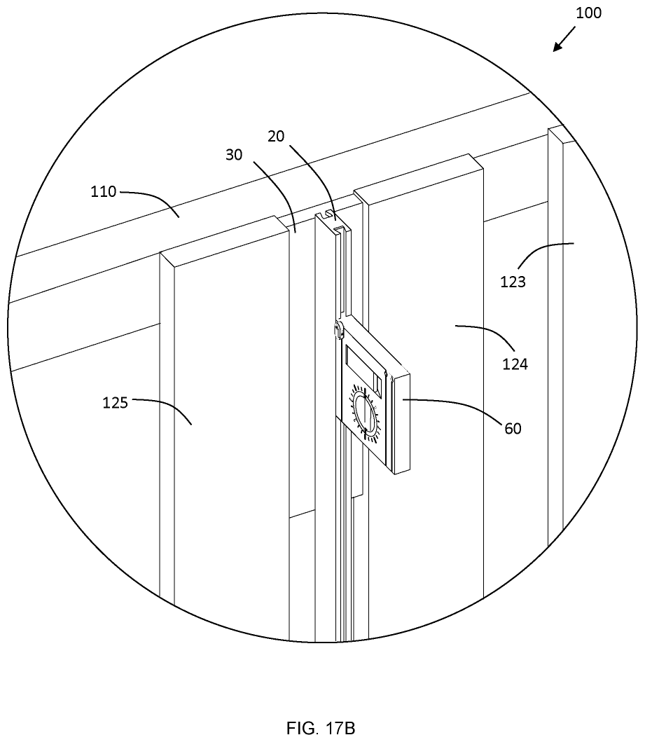

FIGS. 17A and 17B show an isometric and a close-up view of the measuring rod device 100 positioned between two vertical wooden boards 124 and 125 on a fence. A plurality of horizontal stringers 110, 111, and 112 connect the two posts 201 and 202, and a plurality of vertical boards 120, 121, 122, 123, 124, and 125 are attached to the horizontal stringers 110, 111, and 112 in parallel alignment with the posts 201 and 202. The spacers 30, 35 and 36 are used to attach the vertical boards 120, 121, 122, 123, 124, and 125 to the horizontal stringers 110, 111, and 112 at a predetermined spacing with respect to each other. By placing the spacers 30, 35 and 36 against horizontal stringers 110, 111, and 112, aligned with the side of an attached vertical board 124, the next vertical board 125 is set on the opposite side of the spacers 30, 35 and 36. This way users can identify where the vertical boards 120, 121, 122, 123, 124, and 126 should be affixed with a predetermined spacing between each two of them. The predetermined spacing described herein is the horizontal length of the spacers 30, 35 and 36. The spacers 30, 35 and 36 are made in various sizes allowing for different fencing styles.

1) A measuring rod for locating a plurality of predetermined measuring points on a post or an upwardly extending structure, and to construct a fence or a similar structure, comprising:
a) an elongated bar adapted to stand adjacent to a first side of the post;
b) a plurality of spacers slidably and removably attached to a first side of the elongated bar and are configured to lay on a second side of the post while marking the post, and each spacer having a width that is used to evenly space a set of fence boards while constructing the fence;
c) a plurality of markers slidably and removably attached to a second side of the elongated bar, wherein each marker is adapted to lay on the first side of the post and a top edge of each marker provides a marking or a measuring point on the first side of the post to install stringers,
whereby the measuring rod enables rapid and accurate alignment of posts, upward extending structures or horizontal stringers, reducing potential for measurement errors and improving installation efficiency.

2) The measuring rod of claim 1, wherein,
a. the elongated bar having two tapered grooves extending along its length: a first groove on the first side of the elongated bar and a second groove on the second side of the elongated bar which is on the opposite side of the first side, wherein a steel sheet is embedded in a base surface of the first groove and a plurality of magnets are embedded in a base surface of the second groove;
b. each of the plurality of the markers having a male wedge extending along their length on one side and each of the plurality of the spacers having a male wedge positioned on their surface extending along their length, configured to fit within the first and second grooves, respectively, thereby sliding along the length of the elongated bar;
c. a male wedge steel sheet is embedded in the base surface of each male wedges of the plurality of the spacers configured to provide the magnetic attraction between the spacers and the magnets embedded in the first groove of the elongated bar, thereby the plurality of the spacers secure into the elongated bar upon being inserted into the first groove, and
d. a locking mechanism to lock each marker to the elongated bar.

3) The measuring rod of claim 2, wherein the locking mechanism comprising: a lever positioned on a surface of each marker; a magnet positioned in a recess on the male wedge of each marker, and a linkage bar positioned inside each marker connected to the lever from one end and the magnet from the other end, whereby the lever is configured to pull and push the linkage bar and the magnet upon being pulled and pressed, respectively,
whereby in an active state, the magnet pushed to level with the male wedge of each marker and in an inactive state the magnet is pulled to move inside the recess, whereby upon inserting the male wedge of each marker into the second groove of the elongated bar, the magnetic attraction between the magnet and the steel sheet embedded in the second grove increases in the active state securing each marker to the elongated bar and the magnetic attraction between the magnet and the steel sheet embedded in the second grove decreases in the inactive state releasing the marker from the elongated bar.

4) The measuring rod of claim 1, wherein the elongated bar comprises a plurality of segmented elements arranged lengthwise to form a continuous configuration of the elongated bar.

5) The measuring rod of claim 1, wherein each marker has a 360 degree rotating spirit level.

6) The measuring rod of claim 1, wherein each marker further having a plurality of vertical marking lines to indicate specific measurement points, and wherein each vertical marking line corresponds to one of a plurality of fence styles.

7) The measuring rod of claim 1, wherein the elongated bar further has measurement scale.

8) The measuring rod of claim 1, further having an extension leg connected to the elongated bar.

9) The measuring rod of claim 8, wherein the extension leg has a height adjustment mechanism, and a locking mechanism to secure it in place once adjusted.

10) The measuring rod of claim 1, further having a strap to wrap around a post or an upwardly extending structure.

11) The measuring rod of claim 10, wherein the strap comprising a free end that has a hook, and the strap is housed within a strap body having a male connector, whereby the strap is configured to wrap around a post and lock to the male connector on the strap body, and further having a rotary knob on the strap body configured to retract the strap into the strap body, thereby tightening the strap securely around the post and retracting any excess strap.

12) The measuring rod of claim 1, further having a laser attachable on each marker, to shine vertical and horizontal laser lines, allowing for precise alignment of posts, stringers and boards during installation.

13) The measuring rod of claim 12, wherein the laser comprises adjustable settings for varying brightness based on ambient light conditions.

14) The measuring rod of claim 1, wherein the elongated bar is constructed from a lightweight, durable material for ease of transport.

15) The measuring rod of claim 1, wherein the width of each spacer is 1″, 1.5″, 2″, 2.5″, 3″ or 3.5″.

16) The measuring rod of claim 1, the elongated bar is 5 feet, 6 feet or 8 feet long, and it is made of one piece or several smaller pieces.

17) The measuring rod of claim 1, wherein the plurality of the spacers have grooves carved within their surface, thereby reducing their weight.
